(19) United States
(12) Patent Application Publication
(10) Pub. No.: US 2009/0224554 A1
(43) Pub. Date: Sep. 10, 2009

(54) COMMUNICATIONS TOWER WITH WIND ENERGY PRODUCTION

(76) Inventor: Michael Patrick Flynn, Rancho Santa Fe, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/399,231

(22) Filed: Mar. 6, 2009

Related U.S. Application Data
(60) Provisional application No. 61/034,837, filed on Mar. 7, 2008.

(51) Int. Cl. F03D 9/00; H01Q 9/34; H04B 1/38

(52) U.S. Cl. 290/55; 343/874; 455/73

(57) ABSTRACT

A wireless communications tower comprising antennas and wind turbines integrated into or attached to the tower to generate power to operate the tower.

This application claims the benefit of U.S. Provisional Application Ser. No. 61/034,837, filed Mar. 7, 2008, which application is incorporated herein by reference in its entirety.

### BACKGROUND OF THE INVENTION

Wireless communication towers which include antennas and often radio equipment are utilized throughout all areas of the United States and other countries. The cell towers are usually powered by a domestic local power supply and in remote areas sometimes by battery power, fuel cells, propane or diesel power. Providing power to these antennas is a problem due to availability and cost.

An additional problem is the difficulty that wireless providers have in building antenna towers, particularly in urban and more inhabited areas. This is due to the fact that often the local population do not want the presence of unsightly tall towers in their neighborhood.

### DESCRIPTION OF THE INVENTION

The present invention solves many of the problems discussed above with respect to the building, maintenance and powering of antenna wireless communication towers. The invention comprises an Eco-Tower utilizing renewable energy for powering the communications tower and doing so in a way that is not disturbing to the neighborhood.

The Eco-Tower comprises the use of wind energy to generate some or all of the power to operate the communications facility. The tower structure is integrated to produce wind energy via the same vertical structural elements that house the antennas and other necessary equipment. This allows wireless carriers to be “net energy consumers” by having net metering when connected to a power grid in urban areas.

This system also enhances the wireless carrier's ability to get more height from the local jurisdiction for taller poles and roof mounted structures, since the vertical element is also a reusable power generating (green) source. The carriers could also get tax credits/incentives for some portion of the cost of this structure, thus making these towers cheaper than traditional towers and less costly in those jurisdictions requiring the carrier to put up stealth poles that look like a pine tree, palm, etc. Even with stealth poles, the carriers generally do not get the height they desire for their communication towers. Height, for broadcasting the RF signal, is a key element of a wireless network.

The tower may be built as a complete tower, with or without stackable modules for complete wireless transmission. A second option is to strap-on wind turbines around a tower for power generation, using for instance, a donut type attachment to mount around an existing vertical element.

The intergrated tower has a cable/coax chase to allow cables to continue up the pole, a damper system to minimize vibration and a method of connecting the wind turbine modules to the power grid to allow net power metering. The integration of a wind turbine solution will include a coax cable “chase” inside and/or outside of the vertical structure pole and/or legs, which can be either enclosed or not enclosed.

### BRIEF DESCRIPTION OF THE DRAWINGS

FIGS. 1A and 1B show a Uni-Cell Tower;

FIGS. 2A and 2B show an Array-Cell Tower;

FIG. 3A is a front elevational view of a Monopole Mount;

FIG. 3B is a top view of the Monopole Mount shown in FIG. 3A;

FIG. 3C is a front elevational view of a Monopole Mount with cantilevered small wind turbines;

FIG. 3D is a top view of the Monopole Mount shown in FIG. 3C;

FIG. 4A is a front elevational view of a Lattice Tower Mount; and,

FIG. 4B is a top view of the Lattice Tower Mount.

### DETAILED DESCRIPTION OF THE INVENTION

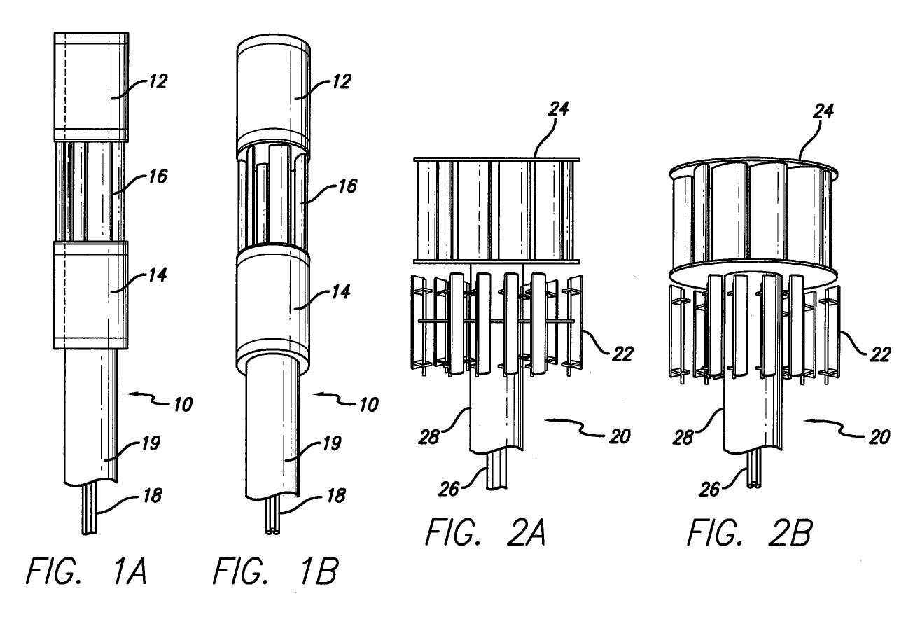

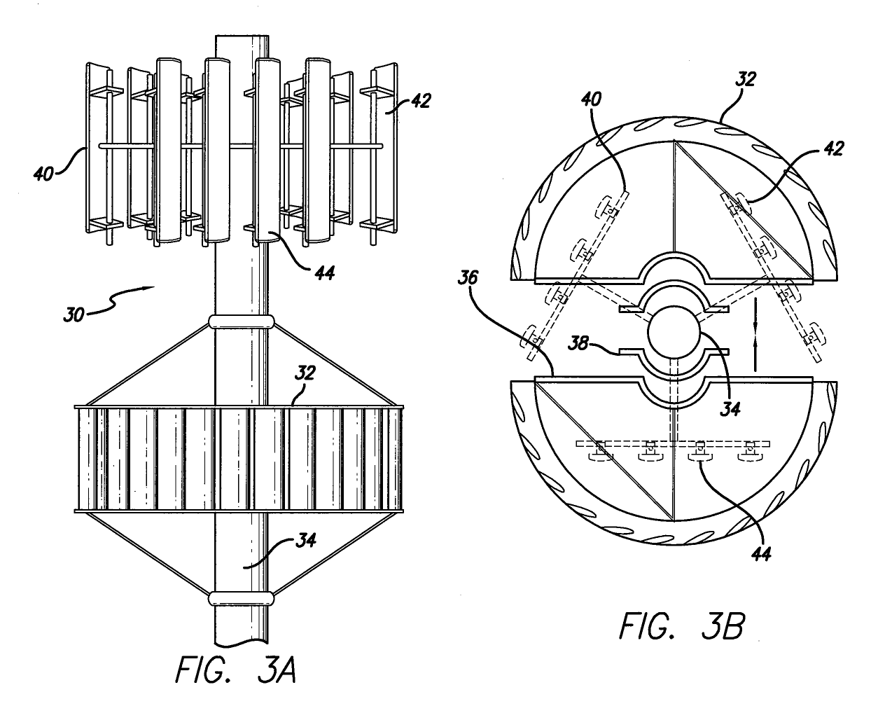

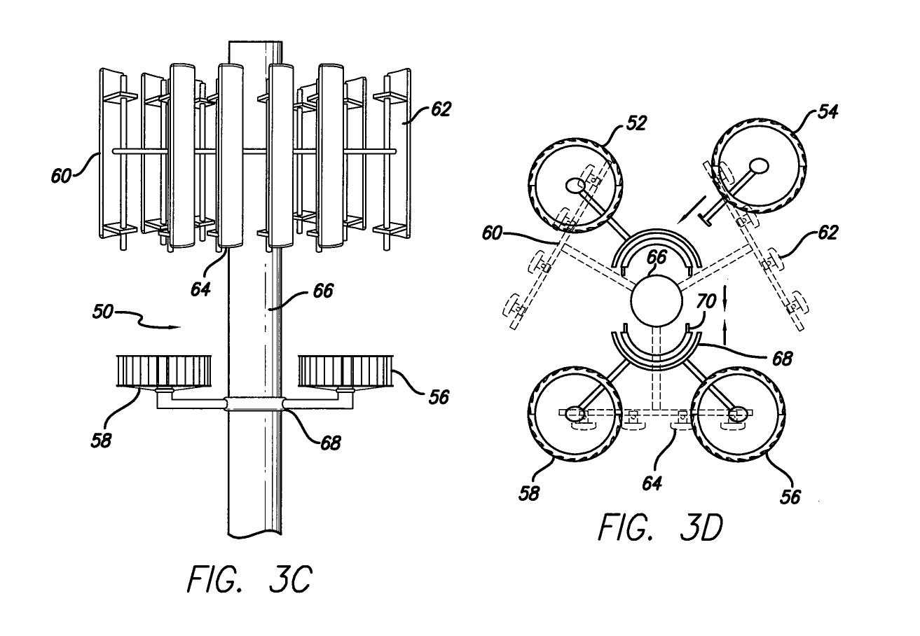

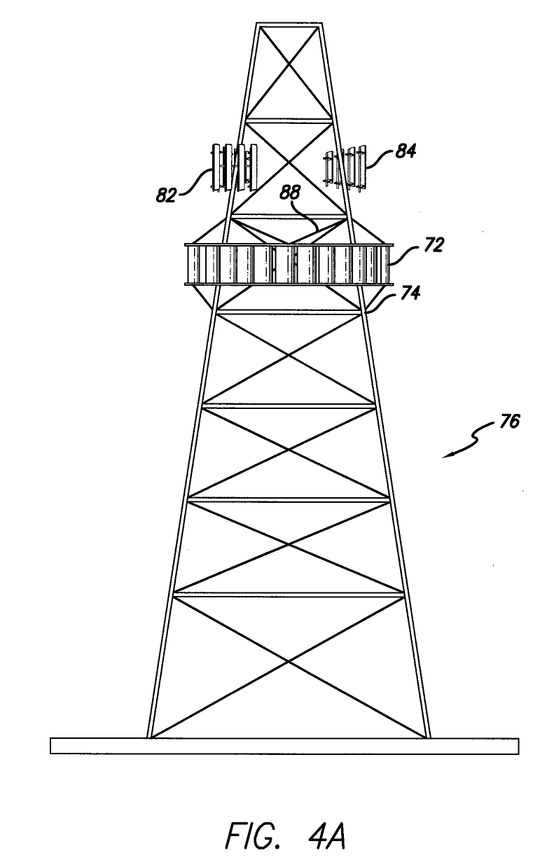

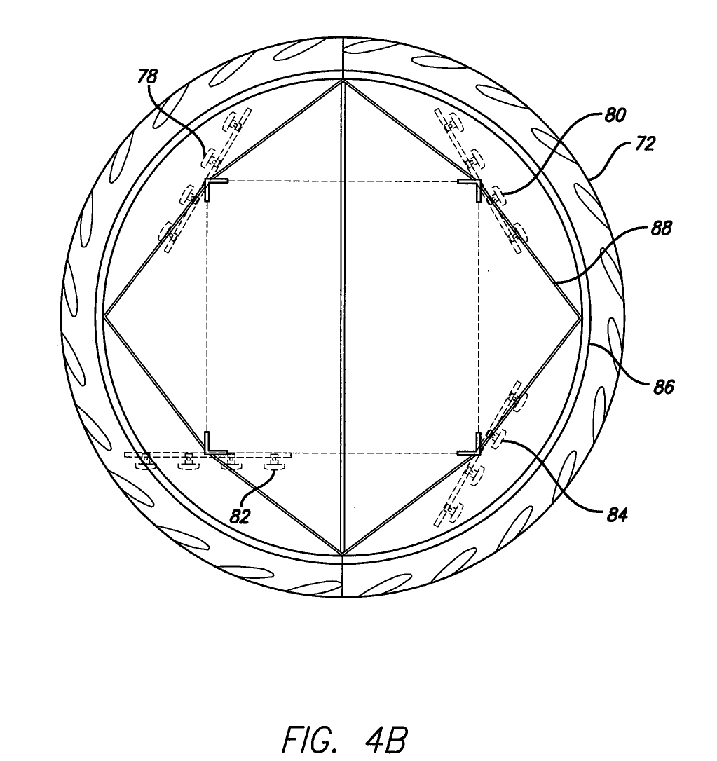

There are at least two types of tower options in the implementation of this invention, integrated towers, shown in FIGS. 1 and 2, and “strap-on” towers, shown in FIGS. 3 and 4.

The first option is a uni-cell tower, shown in FIGS. 1A and 1B where a plurality of modules are stacked and a uni-cell is placed on top of and/or below wind turbines. A uni-cell is a cylinder holding antennas within a fiberglass casing.

Referring now to FIGS. 1 and 2, there is shown a uni-cell tower 10 having two uni-cells 12 and 14 holding antennas and one wind turbine 16 for generating electricity. A drive shaft for the wind turbine and a coax cable 18 runs down a chase in the center of tower pole 19. Depending upon the height of tower 10, multiple wind turbines and uni-cells can be stacked on the uni-cell tower 10. Wind turbine 16 has a small profile compared to the wind turbines often seen which have large fan blades and could not be utilized on cell towers in urban, business or residential areas where a small profile is necessary. These small wind turbines are available through existing manufacturers, such as PacWind, Inc. of Torrance, Calif. These wind turbines are silent and can generate usable power in 5+ mph winds. A drive shaft for the wind turbine passes down inside of tower pole 19.

This embodiment allows for antenna separation or multiple physical antennas per sector, but the options are less available for placing additional antennas with horizontal separation of the antennas. With this modular approach, the carrier places the base plate (the structure on which the modules are stacked) and then places wind cell modules to the desired height. In this embodiment the wireless carriers are not paying to attach equipment to an existing wind turbine, which has vibration, noise and a cost factor, in addition to lease payments to the tower owner. With an integrated wind turbine tower, wireless carriers actually get more height through the jurisdictional process and generally save money on the cost of having to buy towers, by not being forced to purchase stealth towers.

FIGS. 2A and 2B show an Array-Cell Tower 20. In this embodiment the integrated tower 20 is comprised of an array antenna structure 22. This allows the antennas to be mounted with separation, to increase the RF performance and the space available for a number of antennas. In this integrated tower 20, a wind turbine 24 integrated into the tower and/or tower modules, can be larger than the uni-cell application. The wind turbine 24 is incorporated into the structure/module with the same diameter as the antenna structure 22, to enhance the aesthetic appearance of the tower structure.

In the integrated tower, the drive shaft for the turbine 24 is in the center chase and the coax cable 26 may run down outside of the drive shaft in the coax tray inside the pole 28, or it could run down the outside of the pole 28. On legged towers, the coax would run up one or more of the legs. For example, if a carrier permitted a 60 foot monopole, they would purchase stackable modules. The first 3 foot to 10 foot module would be a basic pole, then there would be 2 foot to 10 foot wind turbine modules and the final 10 foot module would be the 10 foot antenna array support section, to reach the 60 foot height The antenna array(s) can be placed above and/or below the wind turbines.

FIGS. 3A, 3B, 4A and 4B show the second tower embodiment.

Referring now to FIGS. 3A and 3B there is shown a Monopole 30 with a “strap-on” wind turbine 32 mounted around an existing tower pole 34. FIG. 3B is an exploded view of wind turbine 32, which is attached to tower pole 34 with mounting ring 36 having vibration damper 38. A set of three antennas 40, 42 and 44 are mounted above wind turbine 32.

FIGS. 3C and 3D show a Monopole 50 with a set of four wind turbines 52, 54, 56 and 58 and a set of three antennas 60, 62 and 64 are attached to tower pole 66. Wind turbines 52, 54, 56 and 58 are mounted on tower pole 66 with a “strap-on” mounting ring (donut mount) 68 having vibration dampers 70. One, or a plurality of small wind turbines (four as shown) are cantilevered off the side of mounting ring 68. The small wind turbines 52, 54, 56, and 58 are spread around mounting ring 68 to provide stability for pole 66.

FIGS. 4A and 4B show an additional “strap-on” embodiment for an existing lattice or multi-legged tower. Wind turbine 72 surrounds lattice structure 74 of multi-legged tower 76. Wind turbine 72 is attached to tower 76 by a mounting ring 86 which is attached to tower 76 by attachment struts 88. Dampers can be placed between the physical structure of tower 76 and mounting ring 86 to minimize vibration.

Four antennas 78, 80, 82, and 84 are attached to lattice tower 76.

For existing towers, there is the option to strap wind turbines onto larger poles, thus larger wind turbine devices can be utilized for electricity generation. By centering the attached wind turbines onto a pole or lattice tower, a more structurally sound tower is produced, that can produce more electricity than smaller cantilevered wind turbines attached to the sides of the tower, cantilevered off the sides, for example.

In areas where there is commercial power available, the power generated by the wind turbines can be sent back to the grid to offset the power usage of the cell sites. In remote applications, the wind turbine structure will produce electricity for use when needed and store power onsite to power the remote cell site when wind power is limited or non-existent. These sites can be self-supporting structures, comprising the combined platform, tower, electronic equipment and batteries, located on a skid to allow “drop and play” deployment.

The Eco-Tower of this invention provides a single structure for power generation in a vertical element for mounting antennas. Cities would be encouraged to place these towers, and allow carriers to use high vertical poles to get additional height for better propagation of far-off signals.

The cost is shared for the telecom site and power generation, because the telecom becomes the purveyor of electricity instead of being a power user. The Eco-Tower combines antenna structure and power creation. Even if the wind turbines don't supply power during equipment run time, the net effect is that the sale of power back to the grid during the times of wind, offset the power consumed by the cell site.

The channeling of bypass air flow from the equipment HDAC's can also be captured to create energy. This may involve having one section of the Eco-Tower designed for equipment air flow recapture and other parts designed for natural wind flow.

An additional feature of the Eco-Tower is the use of excess power that is generated during off-peak hours to create ice and then the ice is used to cool the equipment during peak warmer hours.

The Eco-Tower is a fully integrated system utilizing wind turbines to provide electrical power, in which the tower includes antennas with dampers for vibration. Higher poles will be allowed due to the fact that they generate power and save electricity. The carriers spend less money than building a stealth pole.

In the ordinary course of events, a carrier has to pay rent to add equipment to existing towers. In Applicant's invention the carrier builds the tower because it has self-generating power and may even generate power to be sent back to the grid, which provides income to the carrier.

The Eco-Tower can be built using modules, where the modules are stacked in sections and each section may have a plurality of turbines to generate electricity for that section.

In addition, the carriers who build the towers could get some tax credits and incentives on the cost of the structure, because they are providing renewable energy, thus making these towers cheaper than traditional towers.

As stated above, the wind turbine modules can be attached to existing wireless towers but they also can be attached to existing transmission lines, wood utility poles and even large trees, for power generation, for applications outside of wireless cell sites.

Having thus described the invention, I claim:

1. A wireless communications tower comprising integrated wind turbines to generate power to operate the tower.

2. The wireless communications tower of claim 1 further comprising one or more antennas.

3. The wireless communications tower of claim 1 further comprising radio equipment.

4. A wireless communications tower comprising a tower pole, one or more antennas and one or more wind turbines integrated into the tower pole.

5. The wireless communications tower of claim 4 further comprising a drive shaft for the wind turbines and a coax cable running down a chase in the tower pole.

6. The wireless communications tower of claim 4 further wherein the antennas are uni-cell antennas.

7. The wireless communications tower of claim 4 wherein the antennas are array antennas.

8. A wireless communications tower comprising a tower pole, one or more antennas and one or more wind turbines attached to the tower pole.

9. The wireless communications tower of claim 8 wherein the wind turbines are strap-on wind turbines.

10. The wireless communications tower of claim 8 wherein the wind turbines are strapped onto the tower pole using a mounting ring attached around the tower pole.

11. The wireless communications tower of claim 8 wherein the mounting ring comprises vibration dampers.

12. The wireless communications tower of claim 8 further comprising a drive shaft for the wind turbines and a coax cable running down a chase in the tower pole.

13. The wireless communications tower of claim 10 wherein a plurality of wind turbines are attached to the mounting ring.

14. A wireless communications tower comprising a multi-legged tower, one or more antennas and one or more wind turbines attached to the multi-legged tower.

15. The wireless communications tower of claim 14 wherein the wind turbines are strapped to the multi-legged tower using a mounting ring attached around the multi-legged tower.

16. The wireless communications tower of claim 14 further comprising radio equipment.

17. The wireless communications tower of claim 15 wherein the mounting ring comprises vibration dampers.

18. The wireless communications tower of claim 8 wherein the wind turbines are cantilevered to the sides of the tower.

19. The wireless communications tower of claim 1 further comprising HDAC equipment in which bypass air flow from the HDAC equipment is captured to create energy.

20. The wireless communications tower of claim 1 in which excess power is used to create ice which is used to cool equipment during warm hours.
